(19) United States
(12) Patent Application Publication
(10) Pub. No.: US 2009/0269064 A1
(43) Pub. Date: Oct. 29, 2009

(54) Optical CDMA by Self Heterodyne Filtering

(75) Inventors: Yehezkel Joseph, Petach Tikvah (IL); Dan Sadot, Kfar Bilu (IL)

Correspondence Address: SALTAMAR INNOVATIONS, 1 Mathewson Road, Barrington, RI, 02806, US

(73) Assignee: Ben-Gurion University of the Negev - Research and Development Authority, Beer Sheva (IL)

(21) Appl. No.: 11/908,072

(22) PCT Filed: Mar. 10, 2006
(86) PCT No.: PCT/IL06/00319

§ 371 Date: Aug. 13, 2008

Related U.S. Application Data
(60) Provisional application No. 60/659,878, filed on Mar. 10, 2005.

(51) Int. Cl. H04J 14/00

(52) U.S. Cl. 398/78

(57) ABSTRACT

A new method and system for Optical Code Division Multiple Access (OCDMA) transmission, in which channel selection and rejection are based on dynamic self-heterodyne filtering using differential time delays applied to the data-modulated signals to code and decode the transmissions in each channel. Mach-Zender Interferometers having characteristic delays between their arms are a simple way of performing this coding and decoding. The technique enables the use of narrow linewidth sources and low spectrum spreading. Consequently this technique can be used in next-generation all-optical dynamic networks allowing bandwidth sharing on the one hand, while at the same time eliminating the need for network management and optical switching. Preliminary theoretical calculations predict the system support of up to 15 channels at a data rate of 1 GHz.

### FIELD OF THE INVENTION

The present invention relates to the field of Optical Code Division Multiple Access systems, especially as implemented by the use of a self-heterodyne filtering method.

### BACKGROUND OF THE INVENTION

Optical Code Division Multiple Access (OCDMA) has been recently proposed as an alternative for next-generation access and local area networks (LANs). The motivation for the development of such systems is the need to provide cheap and simple fiber-to-the-home (FTTH) or fiber-to-the-premises (FTTP) systems, preferably based on passive optical networks (PON). The main advantage of OCDMA is the lack of a network management requirement, greatly simplifying the system as compared with, for instance, the use of conventional Wavelength Division Multiple Access (WDMA). There already exist OCDMA systems and the use of coherence multiplexing, implemented as the optical analogies to conventional electronic CDMA systems. Such systems have been described in an article by K. W. Chow et al., entitled “Optical Coherence Multiplexing for Interprocessor Communications,” published in Optical Engineering, vol. 30, no. 3, pp. 337-344, March 1991, and in an article by D. D. Sampson et al., entitled “Photonic Code Division Multiple-Access Communications”, published in Fiber and Integrated Optics, no. 16, pp 129-157, 1997. A major drawback of such implementation is the large required bandwidth resulting from spectrum spreading due to channel coding or coherence manipulation. This imposes a strong limitation on transmission distance.

There therefore exists a need for an OCDMA system without the drawbacks of currently available OCDMA methods.

The disclosures of each of the publications mentioned in this section and in other sections of the specification, are hereby incorporated by reference, each in its entirety.

### SUMMARY OF THE INVENTION

The present invention seeks to provide a new passive optical system and method for providing multiple user access to a single transmission medium without the need to allocate separate wavelengths to each user. This is accomplished by means of an OCDMA scheme based on signal coding and channel separation executed in two dimensions—the time dimension using differential delays applied to the signals, and the frequency dimension, used to filter neighboring channels according to the instantaneous differences between frequencies of the time delayed signals. The data-modulation of the optical signal of each channel is achieved by the impression thereon of a small frequency modulation, which switches the frequency of the signal between two data binary values close to the center frequency of the signal, followed by the generation of two mutually time delayed signals from these data-modulated signal. These signals are then transmitted over the transmission medium to a receiver, where the received signals are further differentially time delayed and then detected within a frequency band significantly less than the range of the frequency modulation. By this process, it is possible to discriminate between signals originating from one channel or another according to the time delay used in the receiver. The frequency modulation can be generated either by means of Wavelength Shift Keying (WSK), or by using the chirp frequency shift when switching a DFB laser on and off.

A number of methods of utilization of the time delay are possible, the most basic being the use of identical time delays in the transmitter and receiver of each separate channel, followed by a dynamic Multi-Access Interference (MAI) noise cancellation process achieved by a Self-Heterodyne Filtering (SHF) technique. The use of self-heterodyning for laser transient measurements is described in co-pending U.S. patent application Ser. No. 11/034,991 for “Measurement of Wavelength Transients in Tunable Lasers”, and in the article by H. Joseph and D. Sadot entitled “A novel self-heterodyne method for combined temporal and spectral high resolution measurement of wavelength transients in tunable lasers”, published in IEEE Photonics Technology letters, Vol. 16, No. 8, pp. 1921-1923, August 2004, both hereby incorporated by reference, each in its entirety.

In practice, the coding of each separate transmission channel is achieved by applying a differential time delay to different components of the transmitted data-modulated field, and decoding is achieved by applying to different components of the received data-modulated field a second differential time delay, either exactly matched or close to the first differential time delay, depending on the modulation and detection scheme used. The resultant field components are interferometrically mixed at the optical receiver to generate a sum field which has self-heterodyne properties which depend on the components present in the sum field. This self-heterodyne field is filtered by output through a receiver operating at electronically characteristic bandwidths, and therefore, much lower than the optical frequency differences of the transmission. According to a basic embodiment of the invention, when the sum field contains components of wavelengths which differ from each other at any instant of time by significantly more than the receiver electronic bandwidth, these components are filtered out by the receiver, and are therefore rejected. Throughout this application, and as claimed, the term bandwidth is understood to refer either to the intrinsic bandwidth of the receiver alone, or to the combination of the receiver and an additional filter added to further limit the receiver bandwidth. There are small portions of the self-heterodyne fields having wavelength regions where are within the bandpass of the receiver, but these are essentially narrow noise regions which can be readily filtered out by means of a low pass filter cutting on at around the data rate frequency. When the sum field contains components of wavelengths which are essentially identical at all times, which will be the case when using matching transmitter and receiver time delays, these components are homodyne detected by the receiver, and the data-modulation is output from the receiver.

The time delay used to generate the different field components from the data-modulated transmitted signal can be produced by any practical means. The time delay may preferably be applied to the transmitted and received data-modulated fields by means of Mach-Zender Interferometers having matched or almost matched differential delay times for the transmitter and receiver MZI's. This is a particularly convenient method of applying such time delays. Alternatively and preferably, the time delay at the transmitter can be generated electronically, by transmitting the data modulated optical signal a second time, at the desired delay time after the first transmission. The field components which traverse identical propagation paths lengths through two MZI's of a single communication channel arrive simultaneously at the detector of the optical receiver, and can thus be detected by conventional homodyne methods to provide the demodulated data signal. Field components which traverse any other propagation paths, whether through the other arm combinations of that first channel, or whether through any of the other channels of the system which are unmatched to the first channel, are substantially wavelength shifted from the field components detected in the first channel, and generate self heterodyne signals which are generally out of the bandwidth of the electronic receiver, and are therefore rejected.

According to the method of data modulation used, other methods of discrimination between the various transmitted channels are preferably used. According to one further preferred method, a time delay is applied in the receiver slightly offset from the time delay used in the transmitter, and the heterodyne signal generated for that channel as a result of the additional offset time delay is detected. According to a further preferred embodiment, the output from the transmitter is phase modulated at a frequency a few times higher than the data rate, and the output data signal detected as the envelope of the phase modulation output frequency.

There is thus provided in accordance with a preferred embodiment of the present invention, a first basic method of transmitting information optically through a medium comprising the steps of:

(i) generating at least two mutually time delayed optical signals data-modulated with the information, the signals having a first differential time delay between them,
(ii) transmitting the mutually time delayed signals over the medium, and receiving the transmitted signals,
(iii) applying a second differential time delay to different parts of the received signals,
(iv) adding the differentially time delayed parts of the received signal to generate an output optical signal, and
(v) detecting the output optical signal on an optical receiver having a predetermined bandwidth such that output optical signals having a frequency outside of the receiver bandwidth are rejected.

According to this method, the values of the first and second differential time delays determine which of the output optical signals are rejected as a result of their frequencies.

There is further provided in accordance with yet another preferred embodiment of the present invention a method as described above, and wherein the at least two mutually time delayed optical signals are generated by splitting an optical signal data-modulated with the information into two separate paths having different optical lengths, such that the first time delay is applied to one of the optical signals.

Alternatively and preferably, the at least two mutually time delayed optical signals may be generated by transmitting an optical signal data-modulated with the information over the medium, and transmitting the optical signal again, electronically delayed from the first transmission by the first time delay.

In accordance with further preferred embodiments of the present invention, in any of the above described methods, the mutually time delayed optical signals are preferably data-modulated with the information by frequency modulating the signals over a range of frequencies. The second differential time delay may preferably be equal to the first differential time delay. In such a case, the range of frequencies may preferably comprise a plurality of chirped frequencies, generated by on-off keying modulation, such that the received signals generate constructive interference at all instants of time when the source of the optical signals is keyed on.

In accordance with a further preferred embodiment of the present invention, the range of frequencies may comprise two frequencies, and the second differential time delay is then made equal to the first differential time delay with the addition of an additional time delay, the additional time delay being such that it enables constructive interference of the two differentially time delayed parts of the received signal at one of the frequencies, and destructive interference at the other frequency. The at least two mutually time delayed optical signals are then preferably output from a tunable laser, and the two frequencies generated by switching of the laser between the two frequencies.

In accordance with still another preferred embodiment of the present invention, there is provided a method as described hereinabove, and wherein the data modulation is performed at a data rate frequency, the method also comprising the step of phase modulating the mutually time delayed signals transmitted through the medium at a frequency higher than the data rate frequency. The phase modulated signal is then preferably modulated by the data modulation, and the optical receiver bandwidth is made such as to transmit the phase modulation frequency within its bandwidth, such that the receiver outputs the data modulation.

There is even further provided in accordance with another preferred embodiment of the present invention, a method as described hereinabove, and wherein the data modulation is performed at a data rate frequency, and wherein the second differential time delay is equal to the first differential time delay with the addition of a further time delay having a magnitude such that a heterodyne signal is generated between the differentially time delayed parts of the received signal, the heterodyne signal having an optical frequency which is higher than the data rate frequency. The heterodyne signal is then preferably modulated by the data modulation signal, and the optical receiver bandwidth is made such as to transmit the heterodyne signal frequency within its bandwidth, such that the receiver outputs the data modulation signal.

Furthermore, in accordance with yet more preferred embodiments of the present invention, in any of the above-described methods, the differentially time delayed parts of the received signal having a difference in frequency outside of the receiver bandwidth preferably generate a self heterodyne frequency which is filtered out by the receiver. Additionally, differentially time delayed parts of the received signal having essentially no difference in frequency, are preferably homodyne detected by the receiver to output the data modulation.

There is also provided in accordance with a further preferred embodiment of the present invention, any of the previously described methods and wherein the step of receiving the transmitted signals from the medium also comprises receiving other transmitted signals which have undergone a time delay different from the first differential time delay, and wherein the rejected received signals also originate from these other transmitted signals.

In accordance with yet another preferred embodiment of the present invention, there is provided a method as described hereinabove, wherein the differentially time delayed parts of the received signal have instantaneous different frequencies, such that they generate a self-heterodyne signal from the optical signal, and wherein the bandwidth of the optical receiver is such as to filter out components of the self-heterodyne signal having frequencies outside that of the receiver bandwidth.

There is further provided in accordance with still another preferred embodiment of the present invention, a method as described hereinabove, wherein the differentially time delayed parts of the received signal have essentially no instantaneous difference in frequency, such that the optical receiver detects the data-modulation by homodyne detection of the output optical signal.

In accordance with a further preferred embodiment of the present invention, there is also provided a further method as described hereinabove, wherein the differentially time delayed parts of the received signal have an instantaneous difference in frequency, such that the optical receiver detects the data-modulation of the signal by heterodyne detection of the differentially time delayed parts of the received signal, followed by electronic bandpass filtering.

There is also provided in accordance with yet a further preferred embodiment of the present invention, another basic method of transmitting a data-modulated optical communication signal having a range of frequencies through a medium comprising the steps of:

(i) splitting the optical signal into a first and at least a second portion,
(ii) applying a predetermined time delay to the first portion,
(iii) combining the predetermined time delayed first portion and the at least second portion to generate a combined optical signal,
(iv) transmitting the combined optical signal through the medium,
(v) receiving transmissions from the medium including at least the transmitted combined optical signal, and splitting the received combined optical signal into a first and at least a second part,
(vi) applying a second time delay to the first part, and
(vii) adding the time delayed first part and the at least second part to generate a difference output optical signal, and detecting the difference output optical signal on a receiver having a bandwidth significantly less than the range of frequencies, such that output optical signals having a frequency outside of the receiver bandwidth are rejected.

According to another preferred embodiment of the present invention, in this second basic method, the second time delay is preferably made equal to the predetermined time delay applied to the first portion. In this case, the range of frequencies preferably comprises a plurality of chirped frequencies, generated by on-off keying modulation, such that the received signals generate constructive interference at all instants of time when the source of the optical signals is keyed on. Alternatively and preferably, the range of frequencies may preferably comprise two frequencies, and the second time delay is then preferably equal to the predetermined time delay applied to the first portion, with the addition of a further time delay, such that constructive interference of the two mutually delayed signals is enabled at one of the frequencies, and destructive interference at the other frequency. The two frequencies are preferably generated by switching of the source optical signal between the two frequencies.

There is further provided in accordance with yet another preferred embodiment of the present invention, the above described second basic method and wherein the optical communication signal is data modulated at a data rate frequency, the method also comprising the step of phase modulating the combined optical signal transmitted through the medium at a frequency higher than the data rate frequency. In such a case, the phase modulated signal is preferably modulated by the data signal, and the optical receiver bandwidth is preferably such as to transmit the phase modulation frequency, such that the receiver outputs the data signal.

Alternatively and preferably, in the above described second basic method, the optical communication signal is preferably data modulated at a data rate frequency and the time delay is made equal to the predetermined time delay applied to the first portion, with the addition of a further time delay having a magnitude such that a heterodyne signal having an optical frequency difference is generated between the time delayed first part and the at least second part of the received transmitted signals, which is higher than the data rate frequency. In such a method, the heterodyne signal is modulated by the data signal, and the optical receiver bandwidth is preferably such as to transmit the heterodyne signal frequency, such that the receiver outputs the data signal.

In any of the methods based on the second basic method described above, received signals having an instantaneous difference in frequency outside of the receiver bandwidth preferably generate a self heterodyne frequency which is filtered out by the receiver. Additionally and preferably, received signals having essentially no instantaneous difference in frequency, are homodyne detected by the receiver to output the data modulation.

In accordance with still further preferred embodiments of the present invention, there is provided a method as described above and wherein the step of receiving transmissions from the medium also comprises receiving transmitted signals having signal portions from other optical communication signals which have undergone a time delay different from the predetermined time delay, and wherein the rejected received signals originate from the other optical communication signals.

According to another preferred embodiment of the present invention, in the above-mentioned second basic method, the time delayed first part and the at least second part may preferably have instantaneous different frequencies such that they generate a self-heterodyne signal, and the bandwidth of the optical receiver is preferably such as to filter out components of the self-heterodyne signal having frequencies outside that of the receiver bandwidth.

Alternatively and preferably, the time delayed first part and the at least second part have an instantaneous difference in frequency, such that the optical receiver detects the data-modulation of the signal by heterodyne detection of the added combined components, followed by electronic bandpass filtering.

In any of the previously described methods, the bandwidth may preferably arise either from the receiver bandwidth alone, or from the receiver bandwidth and at least one additional bandpass filter. Furthermore, the medium may preferably be either a fiber or a waveguide in an integrated optics circuit. Additionally, the optical signals may preferably be generated by a laser, which could preferably be any of a DBR, GCSR, DFB, FP, VCSEL, or MQW laser.

### BRIEF DESCRIPTION OF THE DRAWINGS

The present invention will be understood and appreciated more fully from the following detailed description, taken in conjunction with the drawings in which:

FIG. 1 illustrates schematically a block diagram of an OCDMA system, constructed and operative according to a first preferred embodiment of the present invention;

FIG. 2 is a schematic drawing of a single communication channel transmitter illustrating the method by which the channel coding/decoding is performed using the dynamic self-heterodyne filtering technique of the present invention;

FIG. 3 schematically illustrates the wavelength-time relationship between the two outputs of the two MZI arms of FIG. 2;

FIG. 4 schematically depicts the electronic output expected from the receiver shown in the embodiment of FIG. 2;

FIG. 5 illustrates schematically a complete single channel transmitter/receiver pair of an OCDMA system, such as that of FIG. 1;

FIG. 6 illustrates the wavelength-time relationship of the four optical fields at the output of the receiver MZI of the communication channel shown in FIG. 5;

FIG. 7 illustrates schematically details of the data detection mechanism of the WSK modulated transmission as shown in the embodiment of FIG. 5 above;

FIG. 8 illustrates schematically a single channel transmitter/receiver pair of an OCDMA system of the present invention, employing a gain modulated laser source to generate a chirp frequency for providing the frequency modulation necessary for operation of this embodiment;

FIG. 9 illustrates schematically a single channel transmitter/receiver pair of an OCDMA system of the present invention, employing phase modulation to generate and detect the data modulation of the channel;

FIG. 10 illustrates schematically the phase modulation detection method of the embodiment of FIG. 9;

FIG. 11 illustrates schematically a single channel transmitter/receiver pair of an OCDMA system of the present invention, employing heterodyne frequency modulation in order to generate and detect the data modulation of the channel;

FIGS. 12 and 13 illustrate two different methods whereby the heterodyne frequency modulation scheme can be applied, using respectively saw tooth modulation, and ramp modulation;

FIG. 14 illustrates schematically the modulated output signal obtained from a heterodyne modulation scheme using a High Non-Linear Fiber; and

FIGS. 15 to 18 schematically illustrate alternative preferred embodiments for generating the transmitter delay time electronically, rather than with an optical delay path, and alternative methods of detecting the received signals after transmission.

### DETAILED DESCRIPTION OF PREFERRED EMBODIMENTS

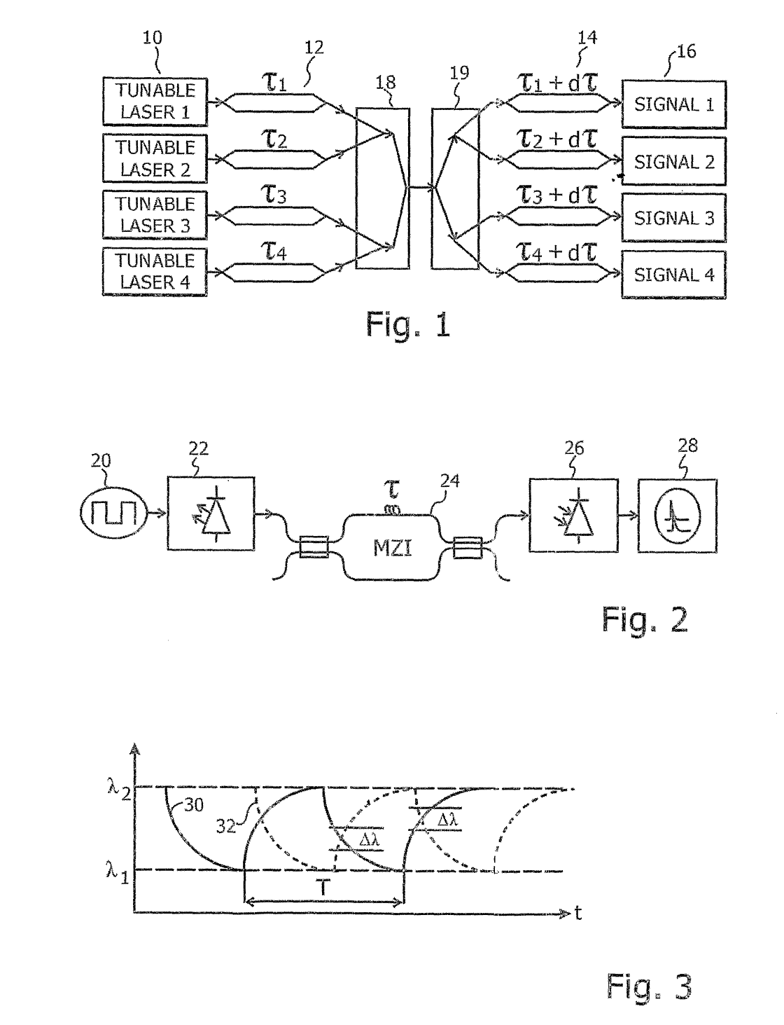

Reference is now made to FIG. 1, which illustrates schematically a block diagram of an OCDMA system, constructed and operative according to a first preferred embodiment of the present invention, and which illustrates the basic operation of the OCDMA method of the present invention. The preferred embodiment of FIG. 1 comprises only 4 communication channels, but it is to be understood that a practical system may comprise many more channels, and the invention is not intended to be limited only to 4 channels. The transmitter of each communication channel consists of a laser 10, which can be of any common type, such as DBR, GCSR, DFB, FP, VCSEL, MQW, such as are known in the art, and an optical multiplexer 12, while each receiver includes an optical demultiplexer 14 and a regular PIN photodiode detector 16. The outputs of all of the transmitter channels are combined, preferably by means of an optical passive star 18, for dispatch over the transmission medium, and are then distributed to all of the receiver channels by a complementary optical passive star 19. The optical multiplexes and demultiplexers are preferably Mach-Zender Interferometers (MZI's), the MZI of each channel having a time delay difference between its arms characteristic of that channel only. The channel specific time delay is the parameter which effectively forms the channel's code. All of the lasers in the system operate at the same carrier wavelength, and the data to be transmitted is frequency modulated onto each laser output, by one of the methods known in the art.

Each channel transceiver pair, k, has a characteristic delay τₖ that is closely matched in the multiplexer 12 and the demultiplexer 14, with the exception of an offset delay difference, dτ, which takes on different values, including zero, according to the type of modulation and demodulation used to convey the data, as described in more detail hereinbelow for several different embodiments. It is this characteristic delay τₖ which is used to implement the channel coding and decoding, which too will be further explained hereinbelow. The WSK demodulation can be performed by methods similar to the electronic frequency discrimination techniques using signal splitting delay and mixing, as in common electronic frequency shift keying (FSK) demodulators, as described for instance in the book Digital Communications by J. G. Proakis, published by McGraw-Hill, New York, 1995. This can preferably be implemented by a small additional delay difference do in each receiver MZI for the frequency discrimination functionality, using the methods described in the articles by G. Katz and D. Sadot, “Inclusive bit error rate analysis for Coherent Optical code-division multiple-access system,” published in Optical Engineering, vol. 41, no. 6, pp. 1227-1231, June 2002, and “A new FSK-based method for coherent optical CDMA systems,” presented in IEEE ISSTA 2000, The International Symposium on Spread Spectrum Techniques and Application, September 2000, New Jersey.

Reference is now made to FIG. 2, which is a more detailed schematic drawing of a single communication channel transmitter, illustrating the method by which the channel coding/decoding is performed using the dynamic self-heterodyne filtering technique of the present invention. According to one preferred method of modulation, a square wave signal 20, representing the communication data to be transmitted by the channel, modulates the tuning section of the tunable laser 22 between two optical frequencies, designated λ₁ and λ₂. This modulated signal is passed through a Mach-Zender Interferometer (MZI) 24, having a delay difference τ between its two arms. The output from the delayed arm is recombined with the output from the direct arm of the MZI to generate an optical signal having self-heterodyne properties, for dispatch through the transmission medium.

The self heterodyne process may be mathematically represented by the following expression for the instantaneous field i(t) which would be detected at the output of the MZI:

$$i ( t ) = h ( t ) * ℜ [ \begin{matrix}\frac{{\vert {A}_{S} ( t ) \vert}^{2}}{2} + \frac{{\vert {A}_{L} ( t - {τ}_{0} ) \vert}^{2}}{2} + \vert {A}_{S} ( t ) \vert \cdot \\ \vert {A}_{L} ( t - {τ}_{0} ) \vert cos ( {\int }_{0}^{t} {ω}_{IF} ( {t}^{′} ) d {t}^{′} + {φ}_{IF} ( t ) )\end{matrix} ] \qquad ( 1 )$$

where:
h(t) is the electrical receiver impulse response,
* denotes the convolution integral,
[symbol] is the receiver responsivity,
τ₀ is the interferometer delay between the shorter and longer arms of the MZI,
A_{S}(t) and A_{L}(t−τ₀) represent the optical fields at the MZI output after passing through the shorter and longer arms respectively,
ω_{IF}(t)=ωₛₕₒᵣₜ(t)−ω_{long}(t−τ₀) is the self-heterodyne angular frequency resulting from the frequency tuning, and
φ_{IF}=φₛₕₒᵣₜ(t)−φ_{long}(t−τ₀) is the self-heterodyne time varying phase difference resulting from the frequency tuning.

Reference is now made to FIG. 3 which schematically illustrates the wavelength-time relationship between the two outputs of the two MZI arms, as detected on an optical receiver at the combined outputs of the two MZI arms, as shown in FIG. 2. The optical receiver preferably comprises a photodetector 26 whose output signal is processed by an electronic receiver 28. The MZI output consists of two wavelength components resulting from the optical waves propagating through the shorter and longer arms. The continuous line 30 and the dashed line 32 represent the wavelength versus time relationship of the optical field outputs at the shorter and longer arms respectively, with the wavelengths switching from λ₂ to λ₁ as the laser is switched between these two frequencies. The optical receiver 26/28 detects a periodic heterodyne frequency which changes from high frequency to low frequency according to the wavelength difference at the outputs of the two MZI arms.

The differential delay τ between the arms of the MZI should be long enough to cause the received heterodyne frequency to be significantly larger than the receiver's electronic bandwidth. At any point in time, the heterodyne frequency is equal to the difference between the frequencies of the shorter arm output 30 and the longer arm output 32. Because of its limited electronic bandpass, the electronic receiver 28 acts as a Low-Pass Filter (LPF) which effectively only passes a small fraction of the heterodyne high frequency signal associated with the regions marked Δλ in FIG. 3, and filters out the majority of the heterodyne frequencies. Δλ is equal to the electronic LPF bandwidth. These short intervals can be termed wavelength “meetings”.

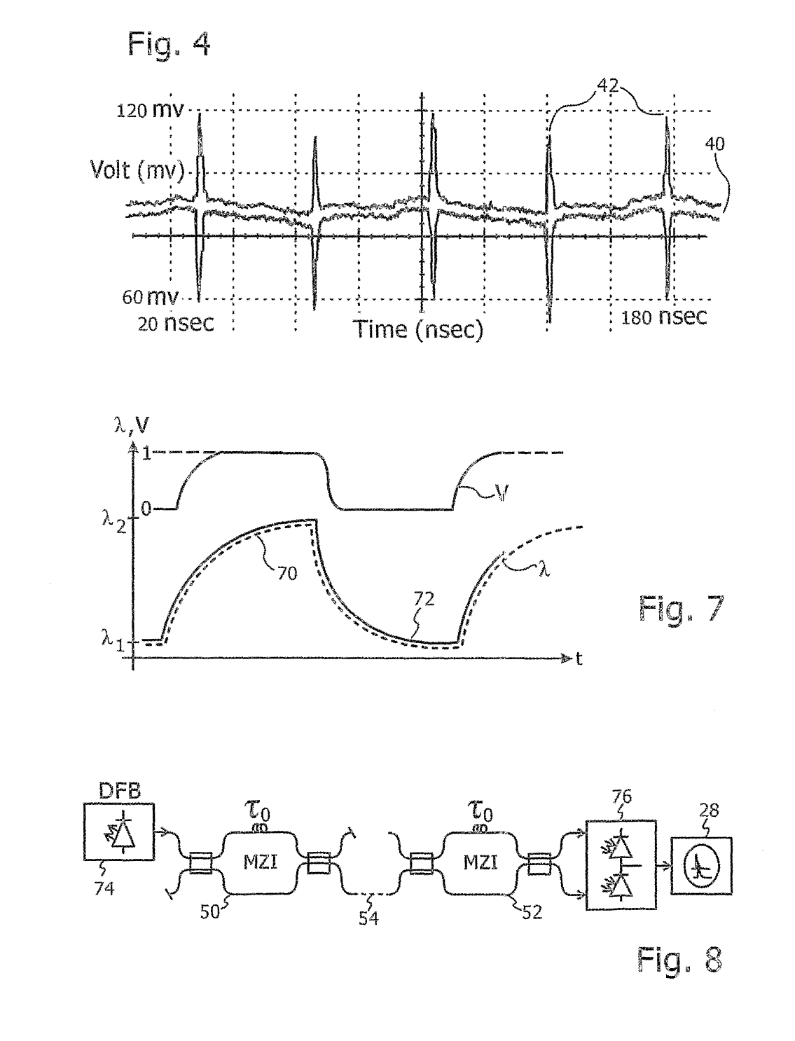

Reference is now made to FIG. 4, which schematically depicts the electronic output expected from such a receiver, as would be displayed, for instance, on a 500 MHz bandwidth electronic oscilloscope. Except for the short period Δt where the “meetings” between the wavelengths occur, the detected signals are beyond the electronic bandwidth of the receiver, and hence no output is detected 40. On the other hand, in the region of the “meetings”, as long as the heterodyne frequency is within the receiver electronic bandwidth, coherent interference is generated between the two optical fields from the two arms of the MZI, and is observed as a high voltage peak 42. The electronic receiver thus performs self-heterodyne filtering (SHF) of the MZI output.

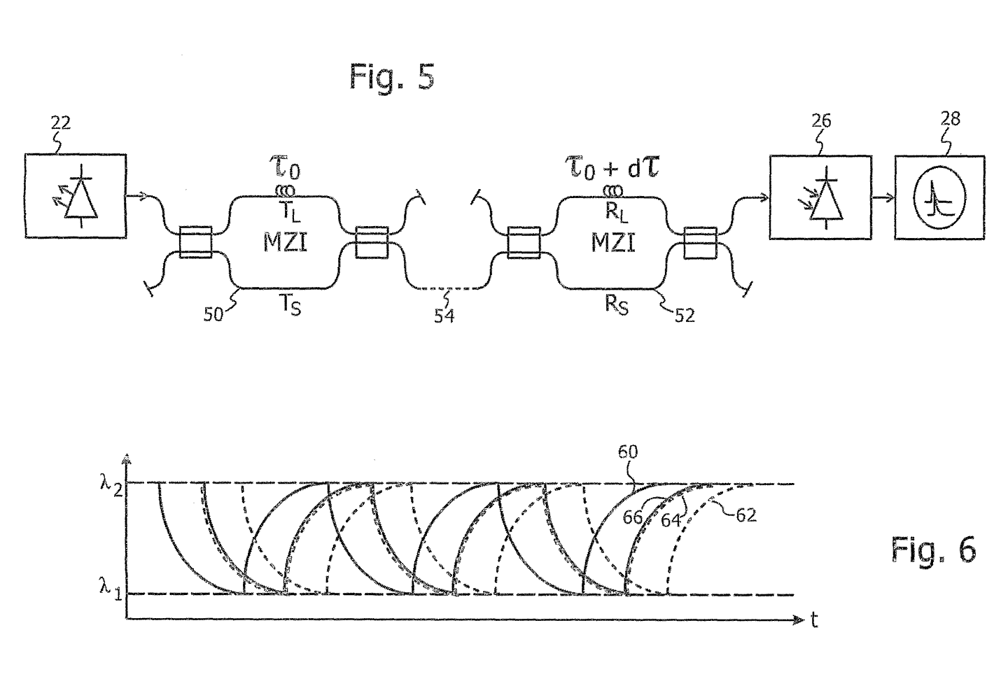

Reference is now made to FIG. 5, which is similar to the arrangement shown in FIG. 3 but illustrates schematically a complete single channel transmitter/receiver pair of an OCDMA system, constructed and operative according to a preferred embodiment of the present invention. The complete channel is represented by a pair of cascaded MZI's 50, 52, having the same differential delay time τ₁, with the propagation medium 54 being understood to be located between the pair. The other circuit elements are labeled the same as those shown in FIG. 2.

There exist four possible optical propagation paths between the laser source 22 and the optical receiver 26/28. The path lengths of the long and short arms of the transmitter MZI are denoted T_{L} and T_{S} respectively, and those of the receiver MZI are denoted R_{L} and R_{S} respectively. Two of these paths, namely those designated (T_{L}+R_{S}) and (T_{S}+R_{L}) are of essentially the same optical length, while the other two path lengths (T_{L}+R_{L}) and (T_{S}+R_{S}) are of significantly different optical lengths. Therefore, for any field emitted by the transmission laser source, at any instant in time, there are four possible fields which are received by the optical receiver 26/28, each corresponding to the input field as delayed by transmission through one of the four possible optical paths.

Reference is now made to FIG. 6, which illustrates the wavelength-time relationship of these four optical fields at the output of the receiver MZI 52. The curves are similar to those shown in FIG. 3, except that each of the four optical fields is represented by a different curve shifted according to the overall time delay that that field undergoes during its propagation through the two MZI's. Two of the four curves 64, 66, overlap, these being the curves associated with the optical fields that propagate through the two matched optical paths, (T_{L}+R_{S}) and (T_{S}+R_{L}). The other curves 60, 62 are those associated respectively with the paths (T_{L}+R_{L}) and (T_{S}+R_{S}), and are significantly shifted in relation to the two matched overlapping curves. The two overlapping curves 64, 66, represent at any given instant in time, two optical field components which reach the receiver 26/28 simultaneously at an identical wavelength, while the other two curves 60, 62, represent optical field components which reach the receiver at different wavelengths.

The two identical field components, both carrying the data modulation, add constructively at λ₂ and destructively at λ₁, and can thus be detected in a conventional homodyne mode at the optical receiver 26/28, and the signal data extracted preferably by WSK demodulation. The other two components, on the other hand, arriving with significantly different wavelengths at any given instant in time, add to form a dynamic heterodyne signal having a frequency that is generally so much higher than the receiver bandwidth that it is rejected by the receiver LPF, except at the narrow band “meeting” events. However, the fields at these “meeting” events result only in the noise peaks shown in FIG. 4, and these can be readily filtered out using a post-detection LPF at the data rate bandwidth.

The overall result of the operation of this channel is thus that the data signal is extracted by conventional homodyne detection of the fields traversing the matched propagation path lengths, while all other fields are rejected by the self-heterodyne filtering (SHF) effect of the present invention. In the same way as the self-heterodyne filtering effect results in rejection of the fields propagated through the unequal path lengths of the first channel shown in FIG. 5, the fields transmitted by any of the paths of the other channels of the OCDMA system of FIG. 1 will also generally be rejected, since they too are not matched with the receiver delay τ₁ of the first channel. In this respect therefore, the code applied to the different transmission channels of this OCDMA is synonymous with the characteristic time delay τ applied to the MZI's of each channel.

The self-heterodyne filtering method of the present invention is effective as long as each transmitted optical field has a different instantaneous wavelength, except at the “meeting” events. During propagation, the optical wavelength is constantly in a transient mode as it is carrying the data modulation. This state is achieved so long as the laser sources are in transient modes, with constantly changing wavelength, which is the situation while they are transmitting data, whether the modulation is done by WSK, or by ON-OFF keying, or by PSK. However, if a sequence of more than one bit is of the same binary value, the laser may reach a steady state wavelength, which is identical for all the transmitters. Consequently, in that case no SHF occurs, and instead, homodyne signals from all of the channels are received simultaneously and detected regardless of their CDMA code, thus generating homodyne interferometric noise. Therefore, to ensure that all lasers are operating continuously in a transient mode, a wavelength scrambling technique is preferably applied to all the transmitters. As an alternative to wavelength scrambling, electronic data encoding methods can be applied to the input data, to avoid the generation of more than two bits having the same logic level.

When a Fabry-Perot (FP) laser is used as the optical signal source, the above described embodiment needs to be amended somewhat, since the FP laser emits several modes simultaneously at different frequencies. Optical waves associated with all of the modes, which have traversed identical optical paths in the transmitter and receiver MZI'S, therefore always generate constructive interference at the receiver, and their data modulation is detected. Waves which traverse unequal paths, whether from the same mode, or from different modes of the same channel, or from different channels, generate high frequency heterodyne signals which are rejected. The heterodyne detection methods described hereinbelow, using an additional offset time delay difference, can also be applied to such a system using FP laser sources.

The above described embodiments have shown the general methods by which the self heterodyne filtering technique is used to generate the channel separation by means of the OCDMA system of the present invention. A number of specific embodiments are now described in order to illustrate practical methods by which the procedure operates in extracting the data modulation being transmitted by each channel of the system.

Reference is now made to FIG. 7, which illustrates schematically details of the data detection mechanism of the WSK modulated transmission as shown in the embodiment of FIG. 5 above. The WSK modulation scheme operates by switching the laser at the data rate between two close-by wavelengths λ₁ and λ₂. The additional small time delay dτ, which is required in this scheme to demodulate the WSK signal, is such that enables constructive interference of the two mutually delayed signals at one of λ₁ and λ₂, and destructive interference at the other one of λ₁ and λ₂. The value of dτ is so small that it does not affect the basic self heterodyne filtering method of the embodiment of FIG. 5, with its rejection of undesired channels, and its acceptance of the overlapping waves which generate the output signal.

FIG. 7 shows an enlarged representation of several cycles of the data rate of this output signal, showing the characteristic curves of the output wavelengths of the overlapping signals, one shown as a solid curve, and the other a dotted curve, switching between the two wavelengths λ₁ and λ₂. In the upper section of the time graph is shown a representation of the output demodulated data signal V, switching between levels representing binary 1 and 0. In region 70, where, after completion of the transient rise, the wavelength is λ₂, the small difference in path length between the two overlapping waves may be such that the overlapping waves are in phase, and thus generate a constructive interference signal, outputting the demodulated data signal 1. On the other hand, in the region 72, where the wavelength is λ₁, because of the preselected value of dτ, the two overlapping waves will have covered a distance such that they will be exactly in anti-phase, and will therefore destructively interfere, giving a demodulated output data signal 0. The demodulated data signal is thus extracted from the homodyne detection of the overlapping waves, by virtue of the predetermined additional delay dτ. It is to be understood that the delineation of in-phase and anti-phase waves in the preferred embodiment of FIG. 7 is only exemplary, and that the waves could just as readily be reversed in practice.

A further method of data modulating the transmission can be achieved using gain modulation operating on the chirp frequency of a laser such as a Distributed Feedback (DFB) laser 74, as shown in the embodiment of FIG. 8. According to this embodiment, the frequency modulation of the transmitted wave is performed by On/Off Keying (OOK) of the laser in accordance with the data to be impressed on the optical signal. This results in different frequencies being generated from the chirp of the laser during switch on and switch off, with the frequency changing from λ₁ to λ₂ during the switch-on chirp, and from λ₂ to λ₁ during the switch-off chirp, using the nomenclature of FIG. 6 as a preferred example. Binary 1 is determined by the laser being on and transmitting, and binary 0 by the laser being either off or transmitting at a low level. According to this scheme, there is no need for any offset time delay in the MZI's of the receivers, and the delay times of the transmitter and receiver MZI's are closely matched.

Detection and rejection of the transmitted and the unwanted neighboring channels then proceeds by the above-described methods of homodyne detection and self-heterodyne filtering respectively, with the data signal being extracted from the detected signal. However, unlike the tunable laser embodiment shown in FIG. 5, since the change in transmitted frequency of the DFB laser is generated as a result in the change in output power of the laser, the optical power received at the detector undergoes changes in level in unison with the changes in frequency. These changes in the optical power would be detected directly and added to the homodyne signal output. In order to eliminate this effect, detection of the signals from the two output arms of the receiver MZI is preferably performed on a balanced detector 76, which cancels out this common mode amplitude change, leaving the modulation signal to be detected without degradation. It is to be understood though that balanced detection is preferably used in all applications of the present system where gain modulated lasers are used, such as FP, VCSEL or MQW lasers.

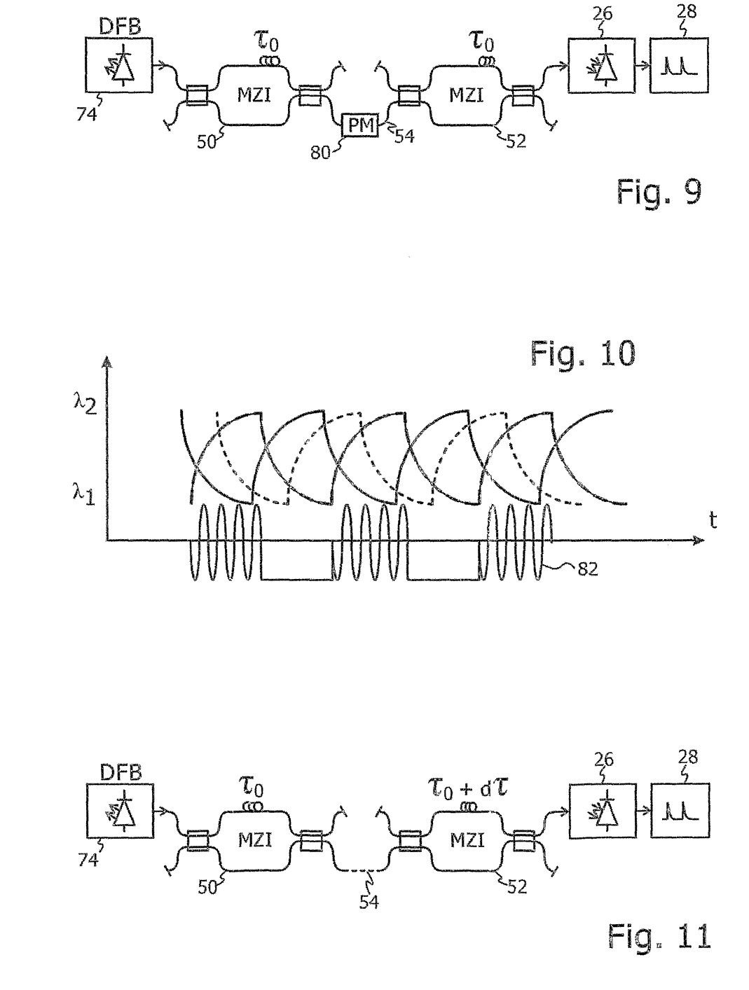

Reference is now made to FIG. 9, which illustrates schematically a single channel transmitter/receiver pair of an OCDMA system, constructed and operative according to a further preferred embodiment of the present invention, and employing phase modulation in order to generate and detect the data modulation of the channel. The component parts of the channel are identical to those shown in the embodiment of FIG. 5, and are thus labeled, except that according to the present embodiment, a phase modulator 80 is added to the channel preferably at the output of the transmitter. The laser 74 is preferably a DFB laser, modulated at the data rate signal. The two mutually time delayed outputs from the transmitter MZI 50 are phase modulated 80 at a frequency several times, and preferably at least 3 times faster than the data rate, and are then transmitted through the medium 54 after the phase modulator 80. In the receiver, the signal detection process proceeds in the same way as described in the embodiment of FIG. 5, with homodyne detection to extract the wanted channel, and SHF to reject neighboring channels, except that the two signals passing through the two arms of the receiver MZI 52 have a phase difference between them which changes at the rate of the phase modulator, i.e. several times per bit of data. Consequently, the phase modulation essentially acts as a “carrier” to the data signal, and after passage through the receiver 28, including a band pass filter which passes the phase modulation frequency, the data signal envelope is detected and output. This detection method is illustrated schematically in FIG. 10, which shows the 4 waves of FIG. 6, with the accepted signal waves overlapping, and at the bottom of the graph, a trace of the output signal showing the phase modulation 82, following the data signal envelope. The use of this phase modulation scheme is able to counteract transmitted signal changes due to environmentally induced phase changes, especially due to temperature change.

Reference is now made to FIG. 11, which illustrates schematically a single channel transmitter/receiver pair of an OCDMA system, constructed and operative according to a further preferred embodiment of the present invention, and employing heterodyne frequency modulation in order to generate and detect the data modulation of the channel. The system is similar in construction to that shown in FIG. 5, except that the additional offset time delay difference, dτ, is chosen to be sufficiently large that an optical frequency difference is generated between the signals passing through the two arms of the receiver MZI, which is higher than the data rate signal frequency. The differential delay path may preferably be of the order of 10 cm. The result of time delay of this length is the generation of a fixed frequency difference between the two nominally overlapping waves, which in the embodiment of FIG. 5, had nominally identical frequencies. This fixed frequency difference presents itself as a constant heterodyne frequency 90, which, as for the embodiment of the phase modulation of FIG. 8, is detected whenever the output signal of the two nominally overlapping waves are detected in the electronic receiver 28.

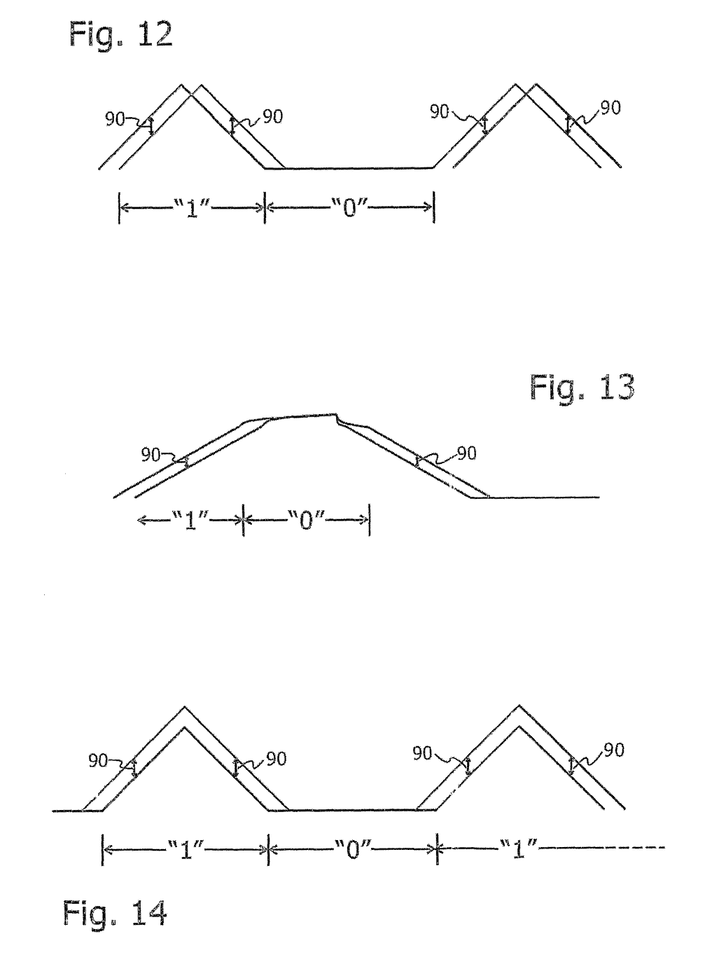

Reference is now made to FIGS. 12 and 13, which show two different methods whereby the heterodyne frequency modulation scheme can be applied. In FIG. 12, the laser is data-modulated with a saw tooth wave, and so long as the two nominally overlapping waves are present at the output of the optical receiver, the heterodyne modulation signal 90 is also present at the output of the electronic receiver after bandpass filtering, and thus outputs a binary 1. When the laser is off, no optical signal is output, such that no heterodyne modulation signal is generated, and a binary 0 results.

FIG. 13 shows the laser data-modulated with a ramp signal. Under these conditions, so long as the ramp modulation is present, an optical output signal with its inherent heterodyne modulation signal is present, and a binary 1 is output from the electronic receiver 28. As soon as the ramp is completed, the frequencies of the two nominally overlapping waves become the same, no optical signal is output, such that no homodyne signal nor heterodyne modulation signal is generated, and a binary 0 results.

Reference is now made to FIG. 14, which illustrates schematically the modulated output signal using a heterodyne modulation scheme which relies on the use of a High Non-Linear Fiber (HNLF) in at least one of the MZI arms, such that the output waves are frequency shifted as shown in FIG. 14, and the heterodyne signal produced from this shift is detected as the demodulated signal.

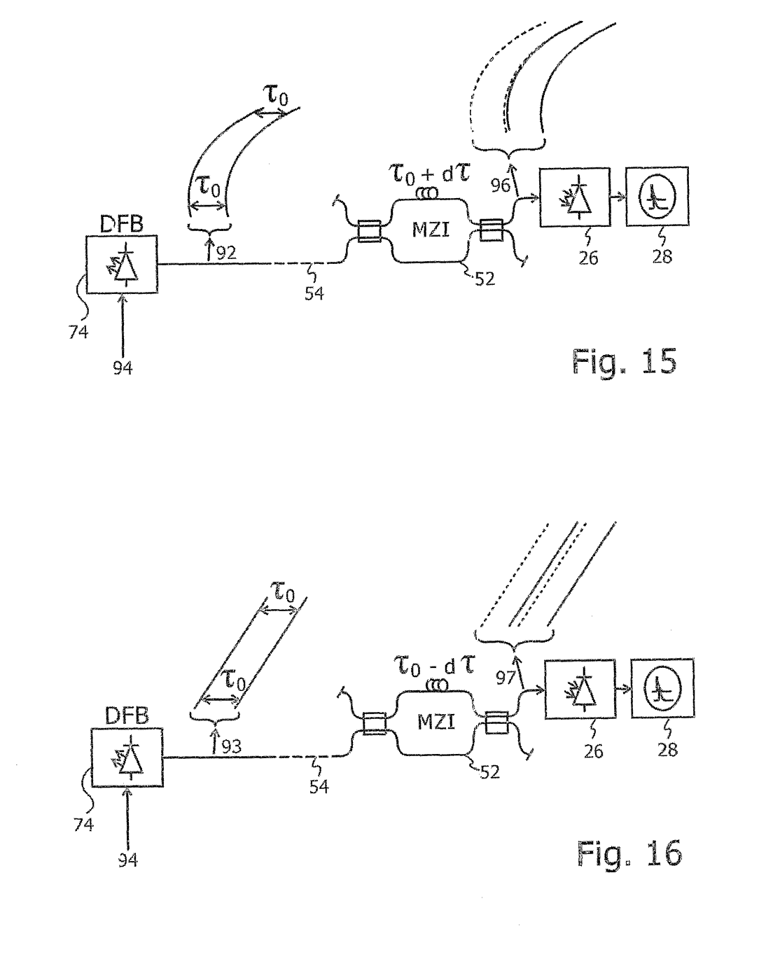

All of the above-described embodiments of the present invention utilize optical path length differences in the arms of MZI's to generate the differential time delay for implementing the signal coding and decoding necessary for executing the invention. However, the invention is not meant to be limited to delays generated by optical path differences, and is operable using delays generated by any other controllable method. Reference is now made to FIGS. 15 to 18, which schematically illustrate alternative preferred embodiments for generating the transmitter delay time electronically, rather than with an optical delay path, and alternative methods of detecting the received signals after transmission.

FIG. 15 shows such a preferred embodiment, equivalent in function to the embodiment of FIG. 11, but in which the time delay applied to the transmitted signals 92 is generated in the laser driver control 94, which is operative to transmit each bit of the data modulated signal a second time after an electronically generated delay of τ₀, such that the transmitted signal is coded with the desired differential delay by electronic means. The receiver channel uses an MZI applied differential delay, as in the embodiment of FIG. 11. The resulting output signals 96 are shown, with the overlapping accepted data signal being homodyne detected. FIG. 16 shows a similar system using electronically generated differential transmission time delay, but in a system with a long offset additional time delay 93, such that heterodyne detection 97 of the demodulated data is performed. The use of electronically generated time delays may have the advantage in that the time delay can be readily changed at will, both to adjust channel coding by changing the overall channel delay τ₀, and to change the small additional offset delay dτ so that switching can be performed between different modulation schemes.

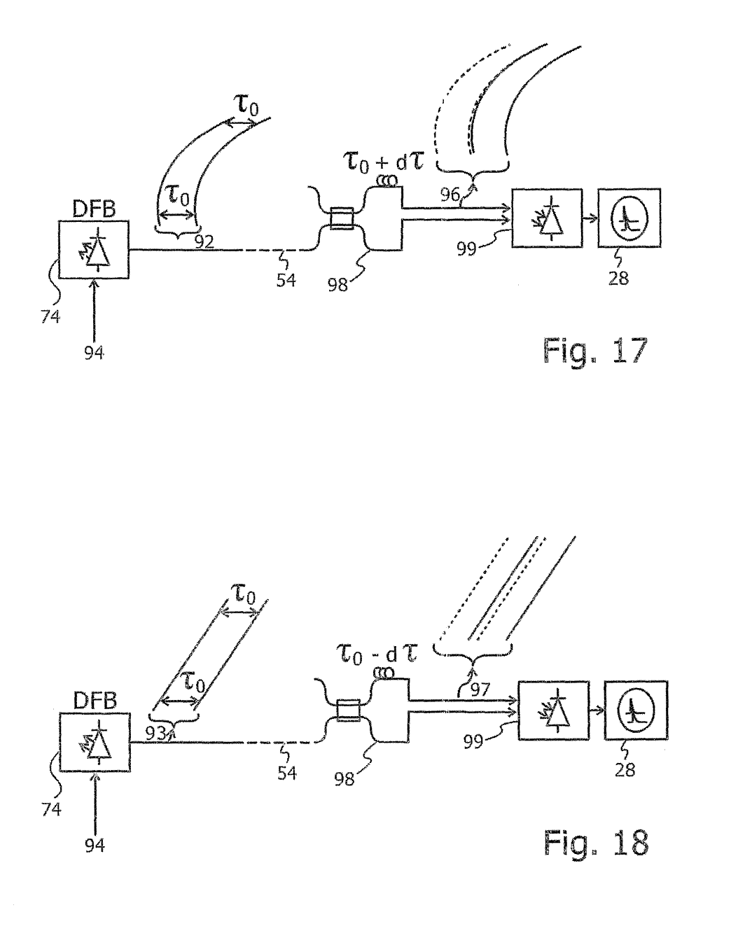

Reference is now made to FIGS. 17 and 18, which show similar electronically generated differential time delay systems to those shown in FIGS. 15 and 16, but using a power splitter 98 with a delay in one of the output arms, and a double fiber detector 99 in the receiver, instead of the MZI used in the embodiments of FIGS. 15 and 16. It is to be understood that such a receiver configuration may also be utilized in any of the previous embodiments, where path length time delay is used in the transmitter.

Although the above mentioned embodiments have been described using a data signal as the modulated information, it is to be understood that the various embodiments of the invention can also be used to demodulate address header information modulated onto the first packet or packets of the transmission, or any other modulated information in addition to the data to be transmitted.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A method of transmitting information optically through a medium comprising the steps of:
generating at least two mutually time delayed optical signals frequency-modulated with said information, said signals having a first differential time delay between them;
transmitting said mutually time delayed signals over said medium, and receiving said transmitted signals;
splitting said received signals into at least two parts, and applying a second differential time delay to said at least two parts of said received signals;
adding said differentially time delayed parts of the received signals to generate an output optical signal, and
detecting said output optical signal on an optical receiver having a limited bandwidth such that output optical signals having a frequency outside of said receiver bandwidth are rejected.

2. A method according to claim 1 and wherein the values of said first and second differential time delays are selected to reject said output optical signals in accordance with their frequencies.

3. A method according to claim 1 and wherein said at least two mutually time delayed optical signals are generated by directing an optical signal frequency-modulated with said information into two separate paths having different optical lengths, such that said first time delay is applied to one of said optical signals.

4. A method according to claim 1 and wherein said at least two mutually time delayed optical signals are generated by transmitting an optical signal frequency-modulated with said information over said medium, and transmitting said optical signal again, electronically delayed from said first transmission by said first time delay.

5. (canceled)

6. A method according to claim 1 and wherein said second differential time delay is equal to said first differential time delay.

7. A method according to claim 6 and wherein said frequency of said modulation comprises a plurality of chirped frequencies, generated by on-off keying modulation, such that said received signals generate constructive interference at all instants of time when the source of said optical signals is keyed on.

8. A method according to claim 1 and wherein said frequency modulation comprises two frequencies, and wherein said second differential time delay is equal to said first differential time delay with the addition of an additional time delay, said additional time delay being such that it enables constructive interference of said two differentially time delayed parts of the received signal at one of said frequencies, and destructive interference at the other frequency.

9. A method according to claim 8 and wherein said at least two mutually time delayed optical signals are output from a tunable laser, and said two frequencies are generated by switching of the laser between said two frequencies.

10. A method according to claim 1 further comprising the step of phase modulating said mutually time delayed signals transmitted through said medium at a frequency higher than said frequency of modulation.

11. A method according to claim 10 and wherein said optical receiver bandwidth is such as to transmit said phase modulation frequency within its bandwidth, such that said receiver outputs said data modulation.

12. A method according to claim 1 and wherein said second differential time delay differs from said first differential time delay by a further time delay having a magnitude such that a heterodyne signal is generated between said differentially time delayed parts of the received signal, said heterodyne signal having an optical frequency which is higher than the frequency of modulation.

13. A method according to claim 12 and wherein said heterodyne signal is modulated by said frequency modulated signal, and wherein said optical receiver bandwidth is such as to transmit the heterodyne signal frequency within its bandwidth, such that said receiver outputs said information.

14. A method according to claim 1 and wherein said differentially time delayed parts of the received signal having a difference in frequency outside of said receiver bandwidth generate a self heterodyne frequency which is filtered out by said receiver.

15. A method according to claim 1, and wherein said differentially time delayed parts of the received signal having essentially no difference in frequency, are homodyne detected by said receiver to output said information.

16. A method according to claim 1, and wherein said step of receiving said transmitted signals from said medium also comprises receiving other transmitted signals which have undergone a time delay different from said first differential time delay, and wherein said other transmitted signals are also rejected by said receiver bandwidth.

17. A method according to claim 1 and wherein said differentially time delayed parts of the received signals have instantaneous different frequencies, such that they generate a self-heterodyne signal from said output optical signal, and wherein said bandwidth of said optical receiver is such as to filter out components of said self-heterodyne signal having frequencies outside that of said receiver bandwidth.

18. A method according to claim 1 and wherein said differentially time delayed parts of the received signals have essentially no instantaneous difference in frequency, such that said optical receiver detects said information by homodyne detection of said output optical signal.

19. A method according to claim 1 and wherein said differentially time delayed parts of the received signals have an instantaneous difference in frequency, such that said optical receiver detects said information by heterodyne detection of said differentially time delayed parts of the received signal, followed by electronic bandpass filtering.

20. (canceled)

21. A method according to claim 1 and wherein said bandwidth is due to said receiver bandwidth and at least one additional bandpass filter.

22. A method according to claim 1 and wherein said medium is at least one of a fiber and a waveguide in an integrated optics circuit.

23. A method according to claim 1 and wherein said optical signals are generated by a laser.

24. (canceled)

25. A method of transmitting a data-modulated optical communication signal having a range of frequencies through a medium comprising the steps of:
splitting said optical signal into a first and at least a second portion;
applying a predetermined time delay to said first portion;
combining said predetermined time delayed first portion and said at least second portion to generate a combined optical signal;
transmitting said combined optical signal through said medium;
receiving transmissions from said medium including at least said transmitted combined optical signal; and
splitting said received combined optical signal into a first and at least a second part;
applying a second time delay to said first part; and
adding said time delayed first part and said at least second part to generate a difference output optical signal, and
detecting said difference output optical signal on a receiver having a bandwidth significantly less than said range of frequencies, such that output optical signals having a frequency outside of said receiver bandwidth are rejected.

26-43. (canceled)

44. A method of characterizing a data-bearing signal transmitted optically through a medium, comprising the steps of:
generating a modulation of the frequency of said signal in accordance with said data;
performing a predetermined time delay manipulation on different portions of said signal to generate at least two mutually time delayed optical signals, the instantaneous difference in frequency between said at least two mutually time delayed optical signals being dependent on said predetermined time delay manipulation performed; and
filtering said at least two mutually time delayed optical signals in order to reject parts of said signal having instantaneous frequencies not characterized by said predetermined time delay manipulation.

45. A method according to claim 44 and wherein said signal is produced by a laser source, and said modulation of the frequency is generated by tuning the frequency of said laser source.

46. A method according to claim 44 and wherein said signal is produced by a laser source, and said modulation of the frequency is generated by amplitude switching of the laser source to produce a frequency chirp.
